(19) United States
(12) Patent Application Publication
(10) Pub. No.: US 2017/0155661 A1
(43) Pub. Date: Jun. 1, 2017

(54) Systems and Methods for Controlling Access to a Computer Device using Traps

(71) Applicant: Thi Chau Nguyen-Huu, Mississauga (CA)

(72) Inventor: Thi Chau Nguyen-Huu, Mississauga (CA)

(21) Appl. No.: 15/286,754

(22) Filed: Oct. 6, 2016

Related U.S. Application Data
(60) Provisional application No. 62/318,376, filed on Apr. 5, 2016.
(60) Provisional application No. 62/261,569, filed on Dec. 1, 2015.

(51) Int. Cl. H04L 29/06

(52) U.S. Cl. CPC H04L 63/105; H04L 63/0846

(57) ABSTRACT

A method and system for controlling access to a first computer using traps. The method and system involves providing a first trap designation by designating a portion of the first computer as being a first trap; receiving from a requesting computer, a request to access the first computer; determining from the request, requested portions of the first computer; and determining if the requested portions comprise the first trap. If the requested portions comprise the first trap, determining if the request to access the first trap is authorized. If and only if the request to access the first trap is authorized, the method and system involves operating the first computer according to a first operating protocol; otherwise, the method and system involves operating the first computer according a second operating protocol. If the requested portions do not comprise the first trap, the method and system involves a third operating protocol.

### RELATED APPLICATIONS

This application claims priority from the U.S. Patent Application Nos. 62/318,376 filed on Apr. 5, 2016 entitled “SYSTEMS AND METHODS FOR CONTROLLING ACCESS TO A COMPUTER DEVICE USING TRAPS” and 62/261,569 filed on Dec. 1, 2015 entitled “SYSTEMS AND METHODS FOR CONTROLLING ACCESS TO A COMPUTER DEVICE USING TRAPS”, which are incorporated herein, in their entirety, by reference.

### FIELD

The described embodiments relate to systems and methods for controlling access to a computer device.

### BACKGROUND

In many situations, individuals and institutions require reliable systems or devices to securely store electronic data. Such data may be stored on local, network, or cloud-based data storage devices. In some cases, access passwords may be used to control access to the data. Despite the use of access passwords, the electronic data may nevertheless be vulnerable to attacks that may enable an unauthorized entity to gain access to the data.

### SUMMARY OF VARIOUS EMBODIMENTS

In accordance with an embodiment, a method of controlling access to a first computer. The method involves providing a first trap designation by designating a first portion of the first computer as being a first trap; receiving, at the first computer from a requesting computer, a request to access the first computer; determining from the request, requested portions of the first computer; and determining if the requested portions comprise the first trap. If the requested portions comprise the first trap, the method involves determining if the request to access the first trap is authorized; otherwise, the method involves operating the first computer according to a third operating protocol. If and only if the request to access the first trap is authorized, the method involves operating the first computer according to a first operating protocol; otherwise, the method involves operating the first computer according to a second operating protocol, the second operating protocol being different from the first operating protocol such that the first computer operates differently in the first operating protocol and the second operating protocol.

In some embodiments, determining if the request to access the first trap is authorized involves storing, at the first computer, trap access instructions defining when the requesting computer is entitled to access portions of the first computer that are designated as a trap. If the first computer has received from the requesting computer, trap access information within a pre-determined time period, and, if the trap access information complies with the trap access instructions, the request to access the first trap can be determined to be authorized; otherwise, the request to access the first trap can be determined to not be authorized.

In some embodiments, receiving, at the first computer, trap access information further involves transmitting, from the first computer to the requesting computer, a request for trap access information.

In some embodiments, the method further involves, before receiving the request to access the first computer: determining if a second computer is authorized to have access to the first computer; and if and only if the second computer is authorized to have access to the first computer, transmitting, from the first computer to the second computer, the trap access instructions.

In some embodiments, the method further involves, before receiving the request to access the first computer: determining if a second computer is authorized to have access to the first computer; and if and only if the second computer is authorized to have access to the first computer, accepting, from the second computer, the trap access instructions.

In some embodiments, the requesting computer is the second computer. In some embodiments, providing a first trap designation further involves maintaining a current trap record, such that whether portions of the first computer are designated as the first trap is determinable from the current trap record; and determining if the requested portions comprise the first trap involves: analyzing the request to access the first computer to determine requested portions of the first computer; and if, based on the current trap record, the requested portions of the first computer include at least some of the first portion of the first computer, determining that the request to access the first computer comprises a request to access the first trap.

In some embodiments, the first portion of the first computer includes at least one of a portion of non-transitory data storage medium of the first computer and data stored in the non-transitory data storage medium of the first computer.

In some embodiments, operating the first computer according to a first operating protocol involves: removing the first trap designation such that the first portion of the first computer is no longer subject to the first trap; and operating the first computer according to a third operating protocol.

In some embodiments, operating the first computer according to a first operating protocol further involves: providing a second trap designation by designating a second portion of the first computer as being a second trap; receiving, at the first computer from a requesting computer, a second request to access the first computer; and determining from the second request, second requested portions of the first computer. If the second requested portions comprise the second trap, determining if the request to access the second trap is authorized; and if and only if the request to access the second trap is authorized, operating the first computer according to the first operating protocol, otherwise operating the first computer according to the second operating protocol; otherwise, operating the first computer according to the third operating protocol.

In some embodiments, the second portion of the first computer is disjoint from the first portion of the first computer.

In some embodiments, the second portion of the first computer includes at least part of the first portion of the first computer, and the method further includes providing a second trap designation by designating the second portion of the first computer as being a second trap either after a pre-determined time period from removing the first trap designation or after operating the first computer according to a third operating protocol.

In some embodiments, operating the first computer according to a second operating protocol involves notifying the second computer that unauthorized access to the first trap has been requested.

In some embodiments, operating the first computer according to a second operating protocol involves operating the first computer to block access by the requesting computer to the first computer.

In some embodiments, operating the first computer to block access by the requesting computer to the first computer involves cryptographically blocking access to the first computer.

In some embodiments, operating the first computer according to a second operating protocol involves permitting access by the requesting computer to buffer portions of the first computer, the buffer portions of the first computer storing substitute data, the substitute data being different from the data stored in the requested portions.

In some embodiments, operating the first computer according to a second operating protocol involves storing, at the first computer, at least one of an internet protocol (IP) address and a computer identifier for the requesting computer.

In some embodiments, operating the first computer according to a third operating protocol involves granting access by the requesting computer to the requested portions of the first computer.

In some embodiments, operating the first computer according to a third operating protocol involves granting conditional access by the requesting computer to the requested portions of the first computer by granting access by the requesting computer to the requested portions of the first computer if and only if additional conditions are satisfied; otherwise, denying access by the requesting computer to the requested portions of the first computer.

In some embodiments, the method further involves determining from the request, requester identifying information identifying the requesting computer; and before receiving the request to access the first computer, determining if a second computer is authorized to have access to the first computer. If and only if the second computer is authorized to have access to the first computer, the method further involves storing, at the first computer, second computer identifying information identifying the second computer; accepting, from the second computer, the trap access instructions; and storing, at the first computer, trap access instructions defining when the requesting computer is entitled to access portions of the first computer that are designated as a trap. In such embodiments, the first trap designation can be relative to the second computer; and determining if the request to access the first trap is authorized involves: receiving, at the first computer from the requesting computer, trap access information within a pre-determined time period; and if and only if the requester identifying information corresponds to the second computer identifying information and the trap access information complies with the trap access instructions, determining that the request to access the first trap is authorized; otherwise, determining that the request to access the first trap is not authorized.

### BRIEF DESCRIPTION OF THE DRAWINGS

A preferred embodiment of the present invention will now be described in detail with reference to the drawings, in which:

FIG. 1 is a block diagram of a target device and a host system in accordance with at least one example embodiment;

FIG. 2 is a block diagram of a cloud-environment having a hypervisor, at least one virtual machine and physical hardware, in accordance with at least one example embodiment;

FIGS. 3A to 3B is a flowchart illustrating a process for controlling access to a computer device using traps when a host system has information about designation of traps, in accordance with at least one example embodiment;

FIG. 3C is a flowchart illustrating part of a process for controlling access to a computer device using traps when a host system does not have information about designation of traps, in accordance with at least one example embodiment;

FIG. 4A is a flowchart illustrating a process for controlling access to a computer device using traps when a host system has information about designation of traps and does not request access to a designated trap, in accordance with at least one example embodiment;

FIG. 4B is a flowchart illustrating a process for controlling access to a computer device using traps when a host system has information about designation of traps and authorization to access a designated trap, in accordance with at least one example embodiment;

FIG. 4C is a flowchart illustrating a process for controlling access to a computer device using traps when a host system has information about designation of traps and does not have authorization to access a designated trap, in accordance with at least one example embodiment;

FIG. 4D is a flowchart illustrating a process for controlling access to a computer device using traps when a host system does not have information about designation of traps and does not request access to a designated trap, in accordance with at least one example embodiment;

FIG. 4E is a flowchart illustrating a process for controlling access to a computer device using traps when a host system does not have information about designation of traps and has authorization to access a designated trap, in accordance with at least one example embodiment; and

FIG. 4F is a flowchart illustrating a process for controlling access to a computer device using traps when a host system does not have information about designation of traps and does not have authorization to access a designated trap, in accordance with at least one example embodiment.

### DETAILED DESCRIPTION OF EXEMPLARY EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices, in known fashion.

Each program may be implemented in a high level procedural or object oriented programming or scripting language, or both, to communicate with a computer system. Alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system can also be considered to be implemented as a non-transitory computer-readable storage medium, configured with a computer program, where the storage medium so configured causes a computer to operate in a specific and pre-defined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, and the like. Non-transitory computer-readable media comprise all computer-readable media, with the exception being a transitory, propagating signal. The term non-transitory is not intended to exclude computer readable media such as a volatile memory or RAM, where the data stored thereon is only temporarily stored. The computer useable instructions can also be in various forms, including compiled and non-compiled code.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, this description and the drawings are not to be considered as limiting the scope of the embodiments described herein in any way, but rather as merely describing the implementation of the various embodiments described herein.

The various embodiments described herein generally relate to a method (and related system) for operating a computer device to control access to the computer device by a computer system. In at least one embodiment, the computer device can be a data storage device, such as a physical disk drive. In at least one embodiment, the data storage device can be a self-encrypting drive (“SED”). In at least one embodiment, the computer device can be physical servers within a datacenter environment.

Access to the computer device by a computer system, or “authentic” computer system, or “authorized” computer system, may be controlled to guard against other computer systems, or “imposters”, from spoofing or masquerading as the authentic computer system. Imposter computer systems can pretend to be the authentic computer system in order to access and obtain data within the computer device.

Generally, in an exemplary embodiment of the invention, the computer component, to which access is being granted (the “target device”), can act as the stakeholder. The target device, while acting as a stakeholder, can verify that a second computer component, for which access is being sought (the “host system”), is the authentic host system. With the target device being the stakeholder, host systems may be regarded as “external” entities seeking to access the stakeholder. That is, both authentic and imposter computer systems may be regarded as external computers systems relative to the target device.

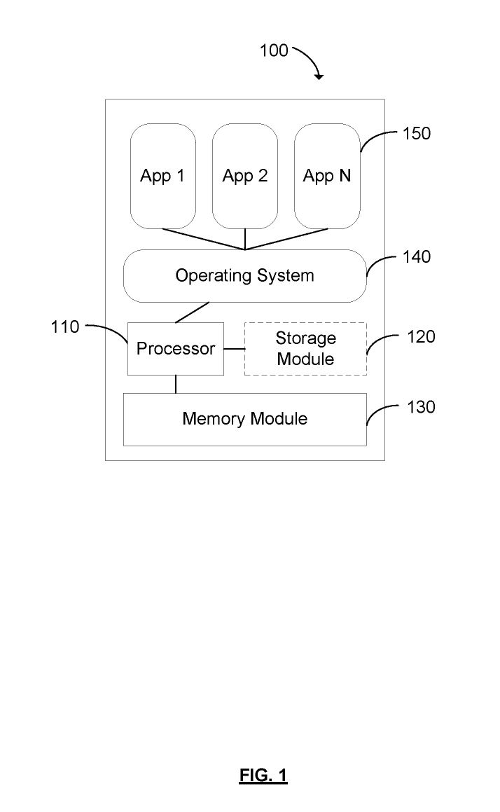

Reference is first made to FIG. 1, which illustrates a block diagram of a computer system 100 comprising hardware and software components, according to at least one example embodiment. The hardware components can comprise at least a processor 110, storage module 120 and a memory module 130. The software components can comprise the operating system software 140 and system applications 150. The operating system software 140 can function to facilitate and manage access to the hardware components by the system applications 150.

While FIG. 1 depicts storage module 120 being a component within the computer system 100, in some embodiments, storage module 120 can be a physical storage device external to the computer system 100. In at least one embodiment, storage module 120 may be a fixed large capacity internal hard disk drive or an externally connected hard disk drive, or solid-state drive. In other embodiments, storage module 120 may be a mapped or mounted network-accessible drive. In some embodiments, the storage module 120 may be an SED.

With respect to the relationship between the storage module 120 and the computer system 100, the storage module 120 may be regarded as a target device and the computer system 100 authorized to access the target device may be regarded as the host system. A session can be started if the host system is authorized to have access to the target device. During the session, the host system may be provided access to the target device and the target device can also monitor the session to determine if the session should be terminated. When the target device determines that the session should be terminated, access to the target device can be blocked.

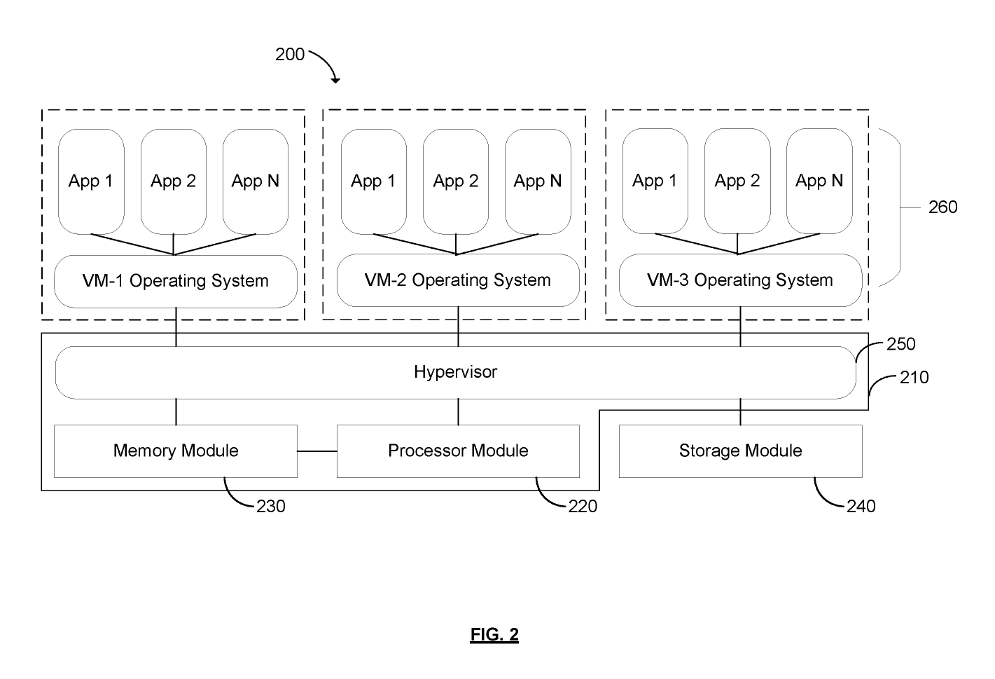

Reference is now made to FIG. 2, which illustrates a block diagram of a cloud-based computing environment 200, according to at least one example embodiment. The cloud-based computing environment can be established using physical servers 210 within a datacenter environment and be managed by a cloud provider. The physical servers 210 can comprise a processor module 220 having one or more computer processors (not shown in FIG. 2), a memory module 230 comprising RAM memory or any high-speed memory, and a storage module 240 comprising large capacity storage such as, for example, hard disk drives and/or solid state drives. In some embodiments the large capacity storage can be an SED.

The physical server 210 can operate a software hypervisor 250 configured to create and manage one or more virtual machines (VMs) 260. The VMs 260 can be allocated physical server resources, by the hypervisor 250, including network resources (not shown in FIG. 2); storage resources such as disk space corresponding to a portion of the physical storage in the storage module 240; and computing resources such as processing resources in the processor module 220 and (RAM) memory corresponding to a portion of the physical memory in the memory module 230. Allocation of server resources can permit the VMs 260 to function as a computer similar to the computer system 100 of FIG. 1. Allocation of server resources to VMs 260 may be static or dynamic. While FIG. 2 depicts storage module 240 being a component external to the physical server 210, in some embodiments, storage module 240 can be a physical storage device within the physical server 210.

The VMs 260 can operate their own operating system and system applications. For example, the operating system labeled “VM-1” can be an open-source operating system such as Linux®, while the operating system labeled “VM-2” can be a proprietary operating system such as the Windows® operating system. As such, although each VM 260 can rely on the same hardware resources, they can nevertheless operate independently with respect to each other.

Additionally, each VM 260 may be associated to a cloud user. The cloud user can be an individual or a group of individuals in a corporation. The cloud user can specify to the cloud provider the computing resources desired. In turn, the cloud provider can create and configure a VM 260 having the appropriate computing resources using the hypervisor 250. For example, one cloud user can request the cloud provider to configure a VM 260 to operate a web server for electronic commerce. Another cloud user can request a VM 260 to be configured to facilitate cloud-based storage. In the latter case, more storage allocation may be justified than in the former case. However, in both cases, data belonging to the VM's respective cloud user may be stored in the respective VM's allocated storage space. Therefore, access to the stored data should only be granted to the cloud user through the VM 260.

The cloud provider generally owns or manages, or both owns and manages, the physical hardware such as the physical storage devices within the storage module 220. Consequently the data belonging to the cloud user can be physically in the possession of the cloud provider, held within the datacenter facility. It is therefore possible that portions of the cloud user's data may be surreptitiously accessed by a malign agent that circumvents the cloud provider's security protections. In cloud storage systems, the cloud user's data can be stored in encrypted form, and may thus be inaccessible by a malign agent. However, when the VM and the cloud user are accessing their data, a malign agent may access that data without the cloud user, or their respective VM's knowledge.

Similar to the computer system 100 of FIG. 1, each of the VMs 260 may be regarded as a host system. Generally, each VM 260, or host system, may only access the portion of the storage module 240, that the hypervisor 250 has allocated to that host system. Thus, each VM 260 may regard the portion of the storage module 240 that is allocated to the VM 260 as a dedicated storage module such as storage module 120 of computer system 100. That is, each portion of the storage module 240 may be regarded as a target device to a host system and the storage module 240 may form a plurality of target devices. Storage module 240 may comprise one physical device, or may alternatively comprise multiple physical devices, and each target device may be provided in one or more of the physical devices.

Access to a target device by a host system in either a computer system environment, such as FIG. 1 for example, or a cloud computing environment, such as FIG. 2 for example, may first require authorization of the host system. As set out above, a session may be started if the host system is authorized to have access to the target device. During the session, the host system may be provided access to the target device. At the same time, the target device can monitor the session to determine if the session should be terminated. When the target device determines that the session should be terminated, access to the target device may be blocked.

The target device in the present disclosure may relate to a storage device such as a disk drive, a solid state disk drive, or an SED. Data stored on the target device may be organized into blocks, or logical blocks. The blocks may further comprise one or more sectors. Logical blocks in the target device may be assigned a unique address such that the logical blocks within the storage device can be accessed individually. A host system may request access to data stored on the target device by issuing an access request to the target device. The access request may relate to read or write operations. The access request may specify logical blocks to be accessed. In some cases, an access request may specify an address range corresponding to particular logical blocks. In some cases, an access request may specify a unique address corresponding to a particular logical block. For example, logical blocks may be assigned a unique address using a linear addressing scheme and an access request may specify a logical block address.

As described in co-pending application for “Systems and Methods for Controlling Access to a Computer Device” (U.S. patent application Ser. No. 14/827,805), the content of which is hereby incorporated by reference, access to a target device such as a self-encrypting drive may be controlled through the exchange of a cryptographic heartbeat between the host system and target device. The heartbeat exchange can comprise exchanging a series of challenges and responses between the target device and the host system, respectively. For instance, in some embodiments, only the authentic host system may be capable of producing a correct response. In such embodiments, if the target device receives a number of incorrect responses greater than a defined threshold, then the target device can terminate the session. Upon termination of the session, the self-encrypting drive can return to a locked state in which the data stored within is not accessible. The exchange of a cryptographic heartbeat may be particularly effective against so-called “hot-swap” cable attacks, wherein after the data storage device is unlocked, an attacker can physically unplug the data cable of the data storage device and plug the unlocked data storage device to another computer, or imposter host system, to access the data stored within.

Exchanging cryptographic heartbeats between a target device and a host system can impede unauthorized host systems masquerading as the authentic host system from directly accessing the target device. However, the exchange of cryptographic heartbeats may increase processing demand and message transmission payload between the host system and the target device.

Furthermore, even with the exchange of cryptographic heartbeats, it may still be possible for an unauthorized host system to access the target device during an active session with an authentic host system. In the case of a data storage device being the target device, an active session between the target device and an authorized host system may provide an opportunity for a malign agent to access the target device through unauthorized access requests without the authentic host system's knowledge.

Examples of malign agents may include, but are not limited to, rogue hypervisors and rogue VMs. A hypervisor may be considered “rogue” if it has been configured to perform unauthorized data operations (e.g. read/write operations) on a target device. For example, a malignant system administrator physically located at the datacenter environment might re-configure the hypervisor through a server console to surreptitiously read the data stored on a target device, or write data to the target device, that only the authentic VM should be able to access. A VM may be considered “rogue” if it has been configured to masquerade as an authentic VM and access the target device of the authentic VM. In other instances, a security flaw of the hypervisor may be exploited by a cloud user through its VM (i.e. an unauthorized host system) to configure the hypervisor to access, on its behalf, the target device authorized for use by another cloud user.

In some embodiments, to impede unauthorized access to the target device during an active session, portions of the target device may be designated as requiring additional information from the host system in order to be accessed by the host system. When such additional information is not received, the target device may terminate the host system's access to the target device. Portions of the target device that may be designated to require additional information for continued access to the target device are called “traps” in the description that follows. In some embodiments, traps may be defined in relation to data, as opposed to in relation to the target device. That is, instead of a portion of the target device being designated to be a trap, certain kind(s) of data may be designated as subject to a trap such that attempts to access that data can trigger the trap. In the description that follows, “portion of the target device” can be used to designate a portion, such as a logical block, of the actual physical target device. Alternatively, “portion of the target device” can be used to designate a notional portion of the target device, such as a particular kind of data. The additional information required for continued access to the target device is called “trap access information” in the description that follows. As described in detail below, trap access information would generally be unknown to an unauthorized host system. In particular, the unauthorized host system would have no knowledge of what constitutes trap access information or when trap access information should be provided. Therefore, when trap access information is not provided or is incorrect or is late, the target device may determine that the host system may be an unauthorized host system and that access by the host system should be terminated (i.e., terminating the active session).

The trap access information may include but is not limited to, a bit sequence, a predetermined code, a count of the number of traps that have been accessed by the host system in the active session, and a count of the number of times that the host system has accessed the target device. The trap access information may be encrypted with a cryptographic key that only the host system has. In some cases where a heartbeat is exchanged between a target device and a host system, the trap access information may be or include the heartbeat itself. The trap access information may also be trap-specific. That is, trap access information for a first trap may be different from trap access information for a second trap. Any suitable information may be used as “trap access information”.

The traps may be static or dynamic with respect to a session. A trap that is static remains a trap for the duration of a session. That is, to access the trap, the host system must provide trap access information. A trap that is dynamic may not remain a trap for the duration of a session. That is, a first portion of the target device may be designated as a first trap for a first time period within the session. To access the first portion within the first time period, the host system must provide trap access information. After the first time period expires, the host system may access the first portion without providing trap access information.

In the case of dynamic traps, a first portion of the target device may be designated as a first trap and a second portion of the target device that is disjoint, or different, from the first portion may be designated as a second trap. For example, if trap designations relate to unique addresses within the storage device, addresses 100 to 199 may be designated as a first trap and addresses 200 to 299 may be designated as a second trap. In this example, the first and second traps are disjoint. In some embodiments, some portions of the target device may be designated as one or more traps; that is, trap designations may overlap. For example, if trap designations relate to unique addresses within the storage device, addresses 100 to 200 may be designated as a first trap and addresses 150 to 250 may be designated as a second trap. In this example, addresses 150 to 200 may be designated as both the first and second traps: the first and second traps are different but not disjoint.

A target device may have any number of traps at any time in the session. That is, trap designations may be contemporaneous. Continuing from the example above of addresses 100 to 200 being designated as a first trap and addresses 150 to 250 being designated as a second trap, addresses 150 to 200 may be designated as a both the first and second traps at the same time. Alternatively, the second trap designation may only begin after the first time period for the first trap expires. Furthermore, the time period of dynamic traps may vary as well. For example, a first trap may persist for 10 minutes while a second trap may persist for 30 minutes. Alternatively, the second trap designation may only begin after the first trap has been accessed.

A target device may maintain a current trap record that can be used to determine whether particular portions of the target device are currently designated as a trap. The current trap record may include a map, or legend, of all portions of the target device and a flag, or an indicator, to indicate whether each portion of the target device is currently a trap. When the target device receives a request for access to particular portions of the target device, the target device can lookup the particular portions in the current trap record to determine whether the particular portions are currently designated as a trap (subject to a trap that currently persists). If the particular portions are currently designated as a trap, the target device may require trap access information. If the particular portions are not currently designated as a trap, the target device may not require trap access information. Alternatively, the current trap record may be a listing of all the designated traps that currently persist. In this case, when the target device receives a request for access to particular portions of the target device, the target device may need to determine whether the particular portions fall within the designated traps that currently persist. Alternatively, the current trap record may be a listing of each of the designated traps and a corresponding time period that each of the designated trap currently persists, or begins and expires. In this case, when the target device receives a request for access to particular portions of the target device, the target device may need to determine which traps currently persist and whether the particular portions fall within the designated traps that currently persist.

In some embodiments, the traps may be designated upon establishment of a session. In some embodiments, dynamic traps may not be designated upon establishment of a session. Instead, dynamic traps may be designated on an ad-hoc basis during the session. Continuing from the example above for dynamic traps, the second portion of the target device to be designated as a trap for a second time period may be identified immediately before the second time period begins.

In some embodiments using dynamic traps, upon receiving correct trap access information, that is, trap access information that complies with the trap access instructions, for a particular trap, the designation of that portion of the target device as a trap may be removed. That is, the trap may terminate when trap access information is provided. When a trap is terminated, that portion of the target device may be accessed thereafter without trap access information. In some embodiments using dynamic traps, upon receiving correct trap access information for a particular trap and removal of the designation of that trap, a different trap may be designated (that is, a different portion of the target device can be designated as a trap).

In some embodiments using dynamic traps, upon receiving correct trap access information for a particular trap, the designation of that portion of the target device as a trap may be suspended. When a trap is suspended, that portion of the target device may be accessed on a limited basis. In some embodiments, the suspension may be time-limited. That is, the trap may be accessed for a limited period of time. Any suitable time period for access to the trap may be used. For example, a trap may be suspended for 10 minutes, during which, the target device may be accessed without triggering the trap. In some embodiments, the suspension may be data-limited. That is, the trap may be accessed for a limited amount of data. In these embodiments, attempting to access more data than the limited or threshold amount of data permitted, can trigger the trap.

In some embodiments, traps may be randomly designated. In some embodiments, traps may be designated based on a pre-determined algorithm, cycle, or schedule. In some embodiments, traps may be designated based on a configuration file stored on the target device.

In some embodiments, a target device may be accessed simultaneously by multiple host systems and trap designations may be host system specific. For example, storage module 240 may be accessed by multiple VMs 260 simultaneously. In another example, the target device may be a network accessible drive that is accessed by several host system concurrently. When trap designations are host system specific, a portion of the target device may be designated as a trap for a first particular host system but that same portion of the target device may not be designated as a trap for a second particular host system. As well, a portion of the target device may be designated as multiple traps simultaneously. That is, a portion of the target device may be designated as a trap for a first particular system and a trap for a second particular system. When trap designations are not host system specific, a portion of the target device may be designated as a trap for all host systems accessing the target device.

In some embodiments, the target device may determine the scheme for traps. In preferred embodiments, the host system may determine the scheme for traps. Generally, host systems may have greater intelligence and awareness of the application, that is, the context of the data stored on the target device. In addition, the host system, or the user of the host system, may have a better idea than the target device about the sensitivity of the data stored on the target device, as well as of the steps likely to be taken by malign agents, trying to access this data. Accordingly, it may be more appropriate for host systems to determine a scheme for traps. In some embodiments, the target device and host system may negotiate the scheme for traps. For example, the host system may determine a level of protection that it requires. The target device may propose schemes for traps as options and the host system may choose from amongst the options. If the host system does not find any of the options presented by the target device to be acceptable, then the host system may terminate the session. In some cases where a heartbeat is exchanged between a target device and a host system, the host system may terminate the session by not exchanging the heartbeat.

In embodiments, where the target device determines the scheme for traps, the target device may generate trap access instructions concerning the scheme of the traps. The target device may transmit trap access instructions to the host system. In embodiments where the host system determines the scheme for traps, the host system can generate and transmit the trap access instructions to the target device. In embodiments where the target device proposes options for trap schemes, the target device may generate and transmit the trap access instructions to the host system at the beginning of the session based on the option selected by the host system.

In some embodiments, in addition to negotiating the scheme for traps, the target device and host system may also negotiate the actions, or operating protocols, in response to events related to the traps. Events related to traps can include whether or not access requests relate to designated traps and whether requested access to traps are authorized or unauthorized. The actions, or operating protocols, that may be taken depend on such events. Generally, the actions taken if an access request relates to designated traps or if an access request is authorized or not authorized will be different. For example, a target device may block access if requested access is unauthorized. Alternatively, a target device may permit access, even if requested access in unauthorized, and also log such unauthorized access requests. To negotiate the scheme for traps, the target device may propose, for each event, options for actions that may be taken in response to that event and the host system may choose from amongst the options.

In some embodiments, the authentic host system and the target device can be the only entities that have knowledge of the traps and the trap access information required to access traps during that session. Trap access instructions can include the information necessary for the host system to access the traps. Trap access instructions may be provided upon initial authentication of the host system, that is, the start of a session. The trap access instructions can indicate the trap access information that the target device expects or should expect.

In some embodiments, the trap access instructions can specify a pre-determined time period within which the trap access information should be received. Any appropriate time period may be used. In some embodiments, if trap access information is late—that is, trap access information is not received by the target device within the pre-determined time period—then the host system can be regarded as being unauthorized to access the trap.

If the trap access instructions provide information about the designation of traps—for example, the portions of the target device to be designated as traps at any time—the target device can expect to receive the trap access information with access requests. Information about the designation of traps may include, but is not limited to, a representation or map of the target device (or the different kinds of data stored on the target device), or a listing of traps and corresponding periods of time during which those portions of the target device may be designated traps. Alternatively, in some embodiments, algorithms can be used to determine traps at any given time. Preferably, before transmitting an access request, the host system may first determine whether it is requesting access to a trap. When the target device uses static traps or dynamic traps determined based on a pre-determined algorithm, cycle, or schedule, the trap access instructions may provide information about the designation of traps. In at least one embodiment, the trap access information may be a signal, whose value is irrelevant. However, the provision of the signal may in itself indicate that the host system is aware that the portion of the target device to which it is requesting access is a trap, thereby indicating that the host system is the authentic host system.

If the trap access instructions do not provide information about the designation of traps, the target device may not expect to receive the trap access information with access requests. Instead, the target device may first receive an access request from the host system. After determining that the access request relates to a trap, the target device may transmit to the host system, a request for trap access information. Requesting trap access information may increase the message transmission payload between the host system and target device. However, the target device may need to request trap access information if no information about the designation of traps, or at least the designation of these traps, was previously sent to the host system. For example, when the target device uses dynamic traps determined on a random and ad-hoc basis, information about the designation of traps may not be provided in trap access instructions at the start of a session. In addition, requesting trap access information may provide better tolerance in the event that the host system, for whatever reason, is not able to provide the trap access information with the access request.

The provision of trap access instructions can allow the target device to use different schemes for traps for different sessions. This may further impede an unauthorized host system by forcing the unauthorized host system to “guess” the scheme and provision of trap access information. For example, in a first active session, the target device may use static traps. In a subsequent session, the target device may use dynamic traps. Alternatively, a combination of static and dynamic traps can be used. The target device may determine the scheme for traps upon establishment of a session.

In some embodiments, an agent, or intermediary, for the authentic host system and the target device can be the only entities that have knowledge of the traps and the trap access information required to access traps during that session. The agent, or intermediary for the authentic host system may store the trap access instructions on behalf of the authentic host system and may provide the trap access information on behalf of the authentic host system.

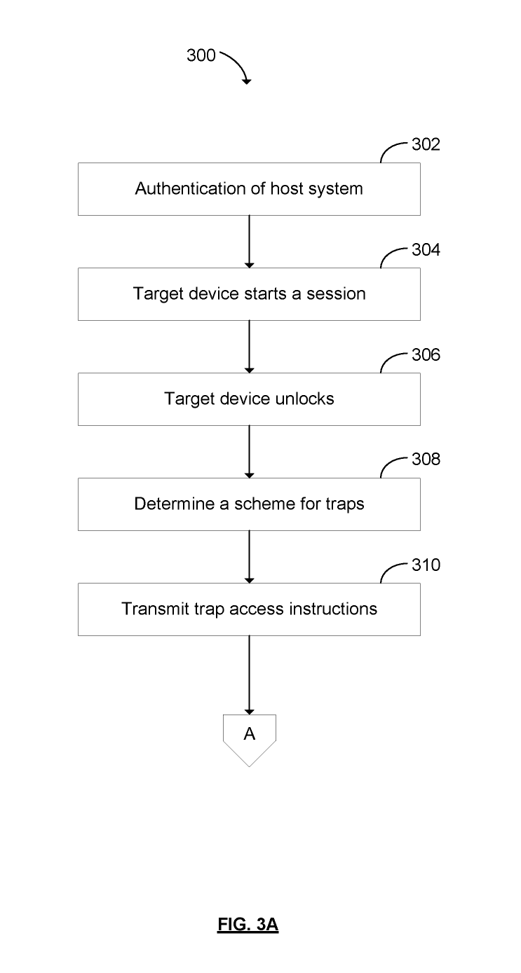

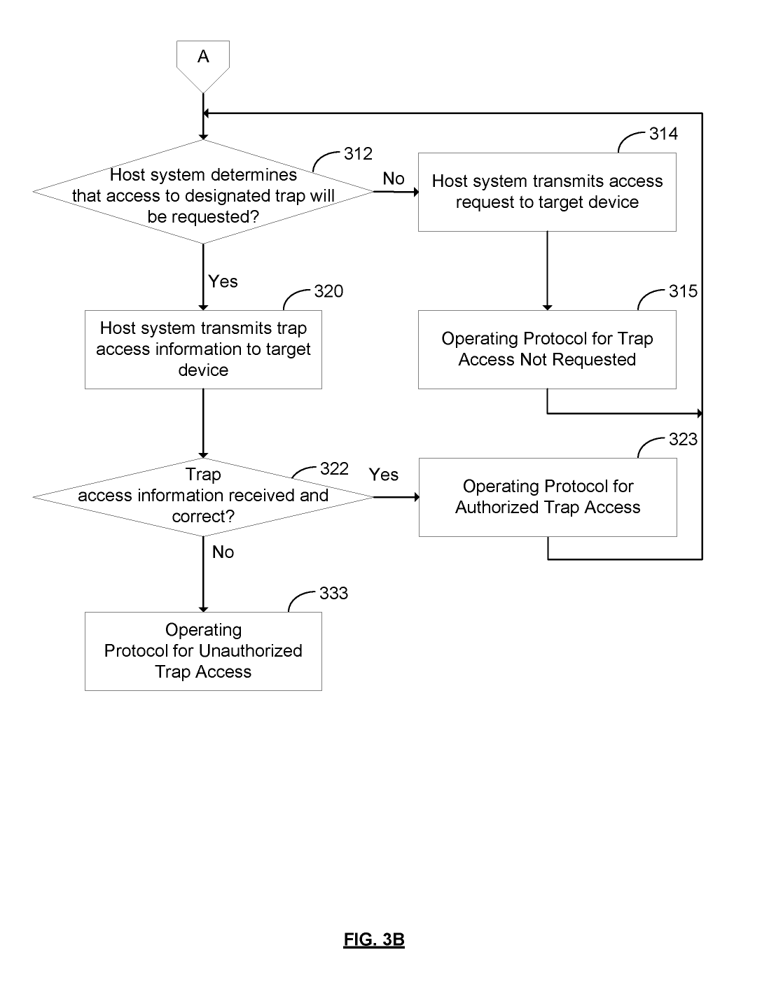

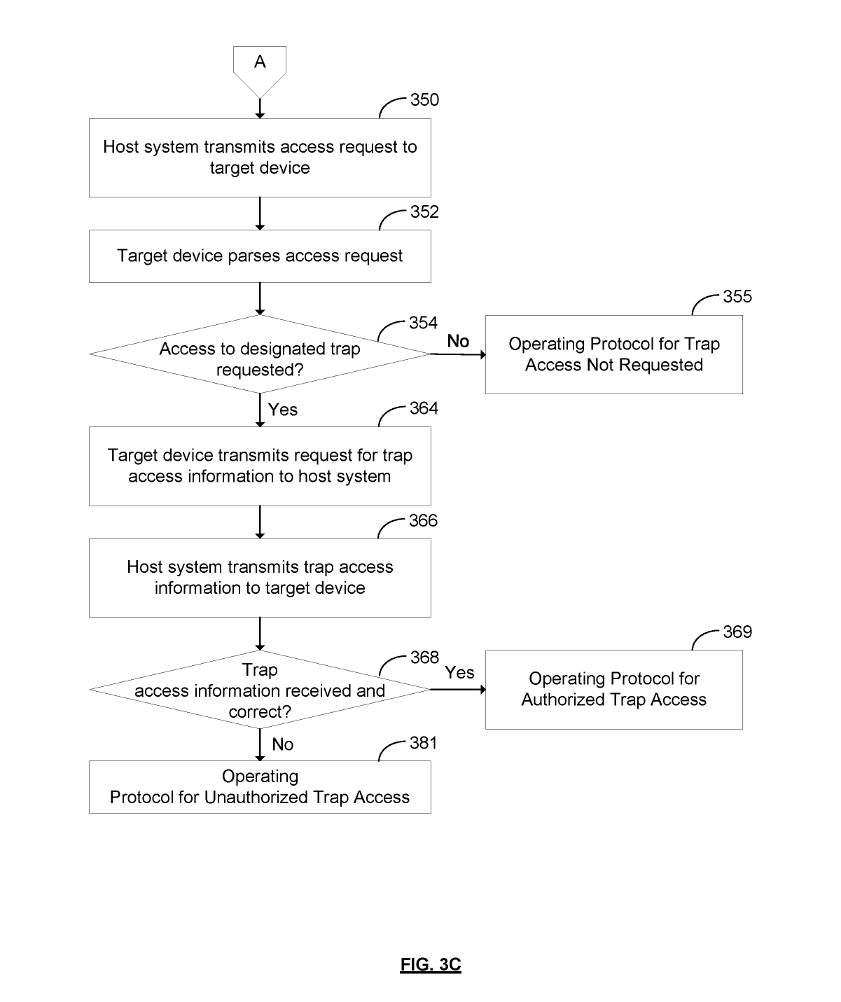

Reference is made to FIGS. 3A and 3B, which illustrates a flowchart 300 of an example process of controlling access to a target device using traps, according to at least one example embodiment.

At step 302, the host system may be authenticated. In some embodiments, authentication of the host system may be provided by a user logging into the host system, or a cloud user logging into a VM operating system. At step 304, upon successful authentication, the target device can start a session after authentication is verified. At step 306, the target device may unlock itself to make the data on the target device accessible. In some embodiments, the target device can make the data accessible to the cloud user via the VM. In some embodiments, unlocking the target device can include disengaging other protective measures (e.g. unencrypting the contents of the target device).

At step 308, a scheme for traps is determined. That is, it is determined whether the traps are static or dynamic, or some combination of both static and dynamic traps. If the traps are dynamic, it may be determined whether the traps will be designated on an ad-hoc basis. If the dynamic traps are not designated on an ad-hoc basis, a plan or schedule for designating dynamic traps for the session may be determined. In some embodiments, a scheme for traps may be determined before the target device is unlocked. In some embodiments, a scheme for traps may be determined before starting a session. Step 310 may be performed by the host system, the target device, or both the host system and the target device.

At step 310, trap access instructions may be generated and transmitted. Step 310 is generally performed by the same entity that performed step 308. That is, in embodiments where the target device determines the scheme for traps, the target device can transmit the trap access instructions to the authentic host system. In embodiments where the host system determines the scheme for traps, the host system can transmit the trap access instructions to the target device.

After step 310, the method may proceed to step 312 of FIG. 3B or step 350 of FIG. 3C, depending on the scheme for traps. FIG. 3B shows steps that may be taken when the host system has information about which portions of the target device are designated as traps at any time. FIG. 3C shows steps that may be taken when the host system does not have information about which portions of the target device are designated as traps.

At step 312, the host system may determine whether the portions of the target device to which it requires access (e.g., access request) are designated as being traps. That is, the host system may first identify a portion of the target device, or a kind of data stored on the target device, to be accessed and then use the information about which portions of the target device are designated as traps to determine whether the identified portion, or kind of data stored on the target device, is a trap. As set out above, an access request may specify an address range or a unique address. In some embodiments, the host system may determine that will be requesting access to a trap if at least some portion of the address range of the access request will overlap with at least some portion of the address range of the traps. In some embodiments, the host system may look-up whether a unique address to be specified in the access request will fall within the address range of the traps.

If the portions of the target device that it will be requesting access to are not designated as being traps, then the host system can send an access request at step 314. Generally, in the circumstances, the host system and target device can operate normally with respect to sending access requests and replying to access requests, respectively. That is, the method can proceed to an operating protocol for trap access not being requested at step 315.

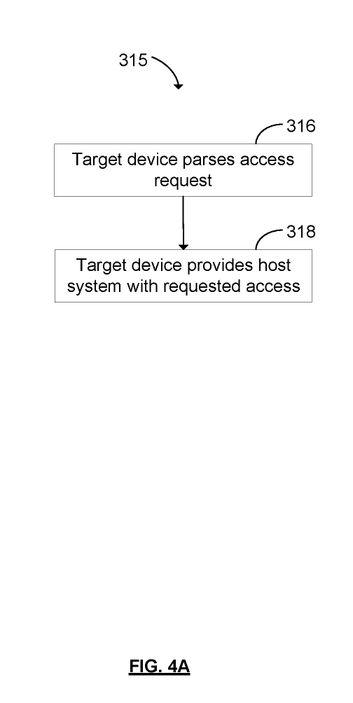

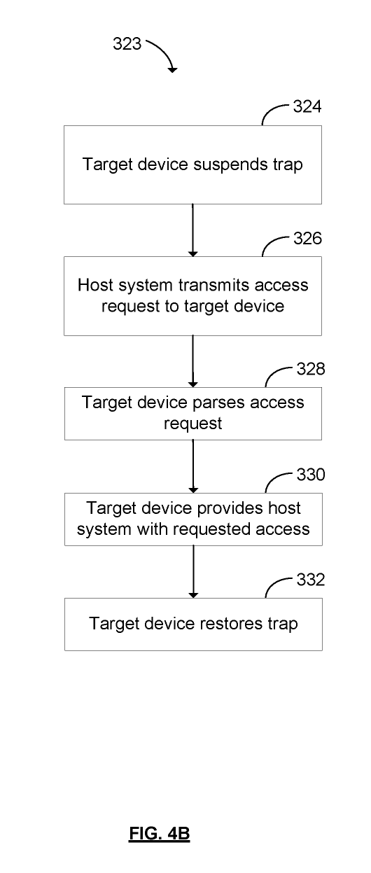

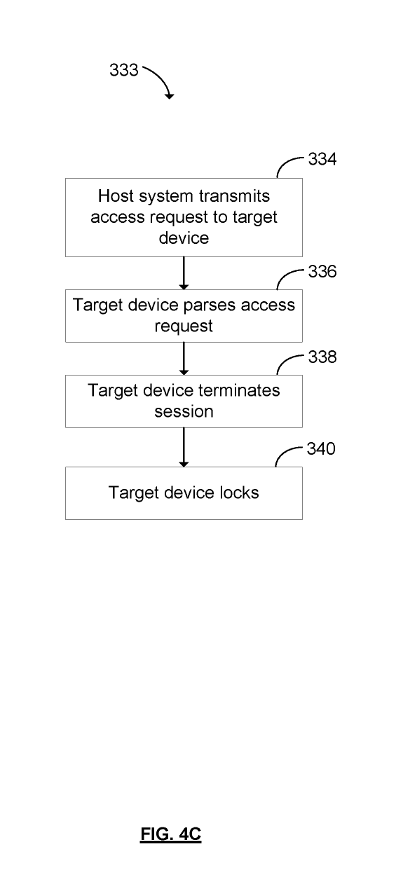

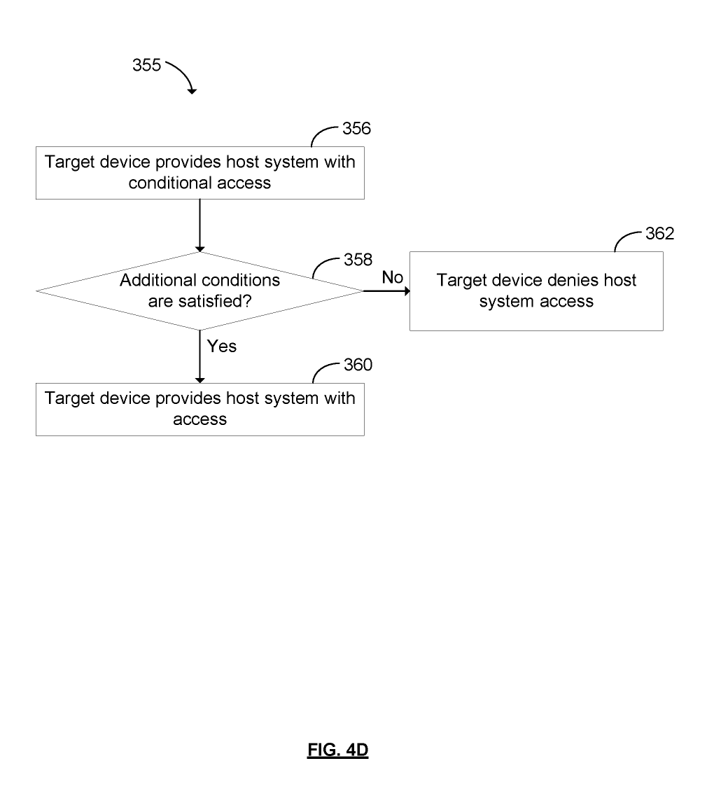

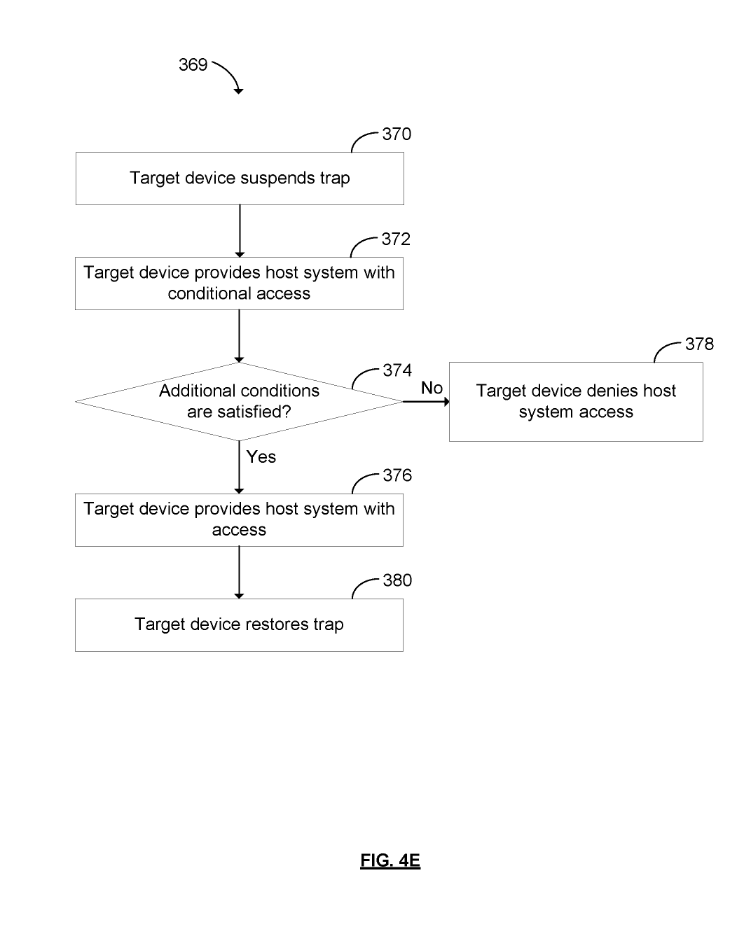

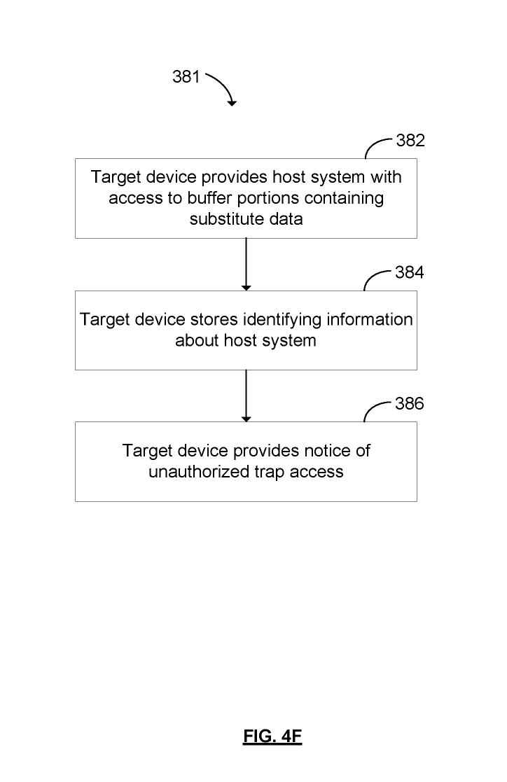

An example operating protocol for trap access not being requested 315 is illustrated in FIG. 4A. At steps 316 and 318, the target device may parse the access request and provide the host system with the requested access. The method can return to step 312 for the next access request.

Referring back to FIG. 3B, if, at step 312, the host system determines that the portions of the target device that it will be requesting access to are designated as being traps, then the host system may transmit trap access information to the target device at step 320. At step 322, the target device may determine whether the trap access information provided by the host system is received and is correct. If the target device determines that the trap access information is correct, the method can proceed to an operating protocol for authorized trap access at step 323.

An example operating protocol for authorized trap access 323 is illustrated in FIG. 4B. At step 324, the target device can suspend the trap so that the target device may be accessed without triggering the trap. After the trap is suspended, the host system can send an access request at step 326, similar to step 314 described above. At steps 328 and 330, the target device may parse the access request and provide the host system with the requested access, similar to steps 316 and 318 described above.

After the target device provides the host system with the requested access at step 330, the target device may restore the trap at step 332. As set out above, in some embodiments, traps may be suspended or removed. When traps are removed, step 332 is omitted and the method can return directly to step 312 after step 330. Even if traps are suspended, in some cases, it may not be necessary to restore the trap. For example, if dynamic traps are used, the expiration of a trap may precede the expiration of the suspension of that trap. Thus, the trap may not need to be restored in step 332.

As set out above, in some embodiments, a different trap may be designated when a trap is removed (not shown in FIG. 3B). The designation of a different trap may be performed after step 330 and before returning to step 312.

Referring back to FIG. 3B, if, at step 322, the target device determines that the trap access information provided by the host system is incorrect or that trap access information was not provided or is late, the method can proceed to an operating protocol for unauthorized trap access 333.

An example operating protocol for authorized trap access 333 is illustrated in FIG. 4C. Step 334 is similar to steps 314 and 326 described above and step 336 is similar to steps 316 and 328 described above. That is, the host system can send an access request at step 334 and the target device can parse the access request 336 and determine that the access request relates to a trap. Thus, the trap may be triggered. The method can proceed to step 338, where the target device can terminate the session and the target device locks itself at step 340. When the session is terminated, access to the target device may be blocked. When the target device locks itself, it may encrypt the data stored within it.

FIG. 3C shows an example method when the host system does not have information about which portions of the target device are designated as traps. At steps 350 and 352, the host system and target device can operate normally with respect to sending access requests and replying to access requests, respectively. That is, the host system may transmit an access request to the target device at step 350, which is similar to steps 314 of FIG. 3B, 326 of FIG. 4B, and 334 of FIG. 4C described above. At step 352, which is similar to steps 316 of FIG. 4A, 328 of FIG. 4B and 336 of FIG. 4C, the target device may parse the access request to determine the unique address or address range that the host system is requesting access to.

At some point during the session, the host system may require access to a portion of the target device that is designated as being a trap. At step 354, the target device can determine whether the host system is requesting access to a trap. If the target device determines that the host system is not requesting access to a trap, the method can proceed to an operating protocol for trap access not being requested at step 355. Step 355 may be similar to step 315 of FIG. 3B except that at step 355, the target device has already parsed the access request at step 352.

An example operating protocol for trap access not being requested 355 is illustrated in FIG. 4D. At step 355, the target device can provide the host system with conditional access to the requested portions. The target device can further determine whether additional conditions are satisfied in order for the host system to gain access to the requested portions. For example, in addition to using traps for controlling access to the target device, the cryptographic heartbeat described above may also be used. In this case, at step 358, the target device may determine whether the host system has satisfied the additional conditions required by the cryptographic heartbeat. If the additional conditions are satisfied, the method can proceed to step 360. At step 360, the target device can provide the host system with access to the requested portions and the method can then return to step 350 for the next access request (not shown in FIG. 4D). If the additional conditions are not satisfied, the method can proceed to step 362. At step 362, the target device can deny the host system access to the requested portions. In some embodiments, after step 362, the method can then return to step 350 for the next access request (not shown in FIG. 4D). In some other embodiments, after step 362, the target device may terminate the session (not shown in FIG. 4D).

Referring back to FIG. 3C, if, at step 354, the target device determines that the host system is requesting access to a trap, the method can proceed to step 364 and the target device can transmit a request for trap access information to the host system. In response to the request for trap access information and having the trap access instructions, the host system may provide the trap access information expected by the target device at step 366.

At step 368, the target device may determine whether the trap access information provided by the host system is received and is correct. The target device may have a pre-determined period of time within which it expects to receive trap access information. Any suitable time period for the pre-determined period of time within which to receive trap access may be used. For example, the target device may expect to receive trap access information within 1 minute. If the trap access information is not received within that time period, then the target device may terminate the session.

If the trap access information is received and is correct, the method may proceed to an operating protocol for authorized trap access at step 369. Step 369 may be similar to step 323 of FIG. 3B with the exception that at step 369, the host system has already transmitted an access request to the target device and the target device has already parsed the access request at steps 350 and 352.

An example operating protocol for authorized trap access 369 is illustrated in FIG. 4E. At step 370, the target device can suspend the trap. Once the trap is suspended, at step 372, the target device can provide the host system with conditional access to the requested portions, that is, the trap. As set out above, access to the target device may be controlled using both traps and the cryptographic heartbeat. After conditional access is granted at step 372, the target device can further determine whether additional conditions are satisfied. Steps 374, 376, and 378 are similar to steps 358, 360, and 362 of FIG. 4D, respectively. In other words, after the trap is suspended at step 372, the operating protocol shown in FIG. 4D for trap access not being requested 355 may be implemented. After the target device provides the host system with access to the requested portions and because the trap was suspended at step 370, the target device may restore the trap at step 380. After step 380, the method returns to step 350 for the next access request.

Referring back to FIG. 3C, if, at step 368, the target device determines that the trap access information is incorrect or is not provided or is late as described above, the method can proceed to an operating protocol for unauthorized trap access 381. Step 381 may be similar to step 333 of FIG. 3B with the exception that at step 381, the host system has already transmitted an access request to the target device and the target device has already parsed the access request at steps 350 and 352.

An example operating protocol for unauthorized trap access 381 is illustrated in FIG. 4F. At step 382, the target device can provide the host system with access to buffer portions of the target device different, from the requested portions. When the access request is a request for a read operation, the buffer portions of the target device may include random data. Buffer portions of the target device may also include substitute data that the host system would not recognize as not being from the requested portions. When the access request is a request for a write operation, the buffer portions of the target device may be empty, random, or any substitute data that can be overwritten. At step 384, the target device can obtain and store identifying information about the host system, such as the internet protocol (IP) address of the host system or a computer identifier for the host system. The identifying information about the host system may be requested by the target device or it may be obtained from any one of the access request, trap access instructions, or trap access information received from the host system, including metadata therein. At step 386, the target device can provide notice that unauthorized trap access was requested and access to substitute data was provided. The notice can be provided at a later time, such as at a regularly scheduled interval, upon subsequent authentication of the host system at step 302, or on an ad-hoc basis. Any appropriate interval may be used. For example, a time-based interval may be annually, quarterly, monthly, or biweekly. The notice can include a total count of the number of times unauthorized trap access was requested and access to substitute data was provided. When a count is used, the notice may be provided when a threshold count is reached; for example, after 10 unauthorized trap access requests. The notice can include stored identifying information about the host system that requested unauthorized trap access. The notice may be provided to the host system, or another appropriate third-party computer.

Alternatively, the target device can provide the host system with the requested access (not shown in FIG. 4F). Similar to steps 384 and 386, the target device can obtain and store identifying information about the host system for such accesses granted without correct trap access information and the target device can provide notice that unauthorized trap access was requested and granted.

Alternatively, if, at step 368, the target device determines that the trap access information is incorrect or is not provided or is late as described above, the method may proceed to an operating protocol for unauthorized trap access 381 that is similar to the operating protocol 333 illustrated in FIG. 4C with the exception that steps 334 and 336 maybe omitted because the host system has already transmitted an access request to the target device and the target device has already parsed the access request at steps 350 and 352. The target device can terminate the session at step 338. In some embodiments, the host system may be able to again gain access to the target device upon starting a new session by re-authenticating itself.

In some embodiments, the target device can terminate the session immediately, or after a delay. Once the target device determines that the session should be terminated, the target device will proceed to terminate. Even if correct trap access information is provided during the delay before session termination, the target device may still proceed to terminate the session. The delay before termination may be provided to enable to the target device to complete processing functions before the session is terminated. Any suitable time period for a delay may be used. In some embodiments, the session may be terminated within seconds or milliseconds.

After the target device terminates the session at step 338, the target device can lock itself at step 340. As mentioned previously, in some embodiments, locking the target device can include engaging other protective measures (e.g. encrypting the contents of the target device).

The process for controlling access to a computer device with traps may be implemented within software components that are not easily altered. For example, in some embodiments, the access counting process may be implemented within the firmware of the target device, SED, or physical disk drives.

The present invention has been described here by way of example only. Various modification and variations may be made to these exemplary embodiments without departing from the spirit and scope of the invention.

1. A method of controlling access to a first computer, the method comprising:
providing a first trap designation by designating a first portion of the first computer as being a first trap;
receiving, at the first computer from a requesting computer, a request to access the first computer;
determining from the request, requested portions of the first computer;
determining if the requested portions comprise the first trap; and
if the requested portions comprise the first trap,
determining if the request to access the first trap is authorized; and
if and only if the request to access the first trap is authorized, operating the first computer according to a first operating protocol,
otherwise, operating the first computer according to a second operating protocol, the second operating protocol being different from the first operating protocol such that the first computer operates differently in the first operating protocol and the second operating protocol;
otherwise, operating the first computer according to a third operating protocol.

2. The method of claim 1, wherein determining if the request to access the first trap is authorized comprises:
storing, at the first computer, trap access instructions defining when the requesting computer is entitled to access portions of the first computer that are designated as a trap; and
if the first computer has received from the requesting computer, trap access information within a pre-determined time period, and, if the trap access information complies with the trap access instructions, determining that the request to access the first trap is authorized;
otherwise, determining that the request to access the first trap is not authorized.

3. The method of claim 2, wherein receiving, at the first computer, trap access information further comprises transmitting, from the first computer to the requesting computer, a request for trap access information.

4. The method of claim 2 further comprising, before receiving the request to access the first computer:
determining if a second computer is authorized to have access to the first computer; and
if and only if the second computer is authorized to have access to the first computer, transmitting, from the first computer to the second computer, the trap access instructions.

5. The method of claim 2 further comprising, before receiving the request to access the first computer:
determining if a second computer is authorized to have access to the first computer; and
if and only if the second computer is authorized to have access to the first computer, accepting, from the second computer, the trap access instructions.

6. The method of claim 4 wherein the requesting computer is the second computer.

7. The method of claim 1, wherein:
providing a first trap designation further comprises maintaining a current trap record, such that whether portions of the first computer are designated as the first trap is determinable from the current trap record; and
determining if the requested portions comprise the first trap comprises:
analyzing the request to access the first computer to determine requested portions of the first computer; and
if, based on the current trap record, the requested portions of the first computer include at least some of the first portion of the first computer, determining that the request to access the first computer comprises a request to access the first trap.

8. The method of claim 1, wherein the first portion of the first computer comprises at least one of a portion of non-transitory data storage medium of the first computer and data stored in the non-transitory data storage medium of the first computer.

9. The method of claim 1, wherein operating the first computer according to a first operating protocol comprises:
removing the first trap designation such that the first portion of the first computer is no longer subject to the first trap; and
operating the first computer according to a third operating protocol.

10. The method of claim 9, wherein operating the first computer according to a first operating protocol further comprises:
providing a second trap designation by designating a second portion of the first computer as being a second trap;
receiving, at the first computer from a requesting computer, a second request to access the first computer;
determining from the second request, second requested portions of the first computer; and
if the second requested portions comprise the second trap,
determining if the request to access the second trap is authorized; and
if and only if the request to access the second trap is authorized, operating the first computer according to the first operating protocol, otherwise operating the first computer according to the second operating protocol;
otherwise, operating the first computer according to the third operating protocol.

11. The method of claim 10, wherein the second portion of the first computer is disjoint from the first portion of the first computer.

12. The method of claim 10, wherein the second portion of the first computer comprises at least part of the first portion of the first computer, the method further comprising providing a second trap designation by designating the second portion of the first computer as being a second trap either after a pre-determined time period from removing the first trap designation or after operating the first computer according to a third operating protocol.

13. The method of claim 4, wherein operating the first computer according to a second operating protocol comprises notifying the second computer that unauthorized access to the first trap has been requested.

14. The method of claim 1, wherein operating the first computer according to a second operating protocol comprises operating the first computer to block access by the requesting computer to the first computer.

15. The method of claim 14, wherein operating the first computer to block access by the requesting computer to the first computer comprises cryptographically blocking access to the first computer.

16. The method of claim 1, wherein operating the first computer according to a second operating protocol comprises permitting access by the requesting computer to buffer portions of the first computer, the buffer portions of the first computer storing substitute data, the substitute data being different from the data stored in the requested portions.

17. The method of claim 1, wherein operating the first computer according to a second operating protocol comprises storing, at the first computer, at least one of an internet protocol (IP) address and a computer identifier for the requesting computer.

18. The method of claim 1, wherein operating the first computer according to a third operating protocol comprises granting access by the requesting computer to the requested portions of the first computer.

19. The method of claim 1, wherein operating the first computer according to a third operating protocol comprises:
granting conditional access by the requesting computer to the requested portions of the first computer by granting access by the requesting computer to the requested portions of the first computer if and only if additional conditions are satisfied;
otherwise, denying access by the requesting computer to the requested portions of the first computer.

20. The method of claim 1, further comprising,
determining from the request, requester identifying information identifying the requesting computer; and
before receiving the request to access the first computer:
determining if a second computer is authorized to have access to the first computer; and
if and only if the second computer is authorized to have access to the first computer,
storing, at the first computer, second computer identifying information identifying the second computer;
accepting, from the second computer, the trap access instructions; and
storing, at the first computer, trap access instructions defining when the requesting computer is entitled to access portions of the first computer that are designated as a trap;
wherein,
the first trap designation is relative to the second computer; and
determining if the request to access the first trap is authorized comprises:
receiving, at the first computer from the requesting computer, trap access information within a pre-determined time period; and
if and only if the requester identifying information corresponds to the second computer identifying information and the trap access information complies with the trap access instructions, determining that the request to access the first trap is authorized;
otherwise, determining that the request to access the first trap is not authorized.

21. A first computer, the first computer comprising:
a communication port for communicating with one or more external computers, the one or more external computers comprising a requesting computer;
a non-transitory computer-readable data storage medium for storing restricted information;
a non-transitory computer-readable data storage medium storing instructions; and
a processor configured to execute the instructions, the instructions for:
providing a first trap designation by designating a first portion of the first computer as being a first trap;
receiving, at the first computer from a requesting computer, a request to access the first computer;
determining from the request, requested portions of the first computer;
determining if the requested portions comprise the first trap; and
if the requested portions comprise the first trap,
determining if the request to access the first trap is authorized; and
if and only if the request to access the first trap is authorized, operating the first computer according to a first operating protocol,
otherwise, operating the first computer according to a second operating protocol, the second operating protocol being different from the first operating protocol such that the first computer operates differently in the first operating protocol and the second operating protocol;
otherwise, operating the first computer according to a third operating protocol.
